(19) United States
(12) Patent Application Publication
(10) Pub. No.: US 2021/0110981 A1
(43) Pub. Date: Apr. 15, 2021

(54) PROCESS FOR MANUFACTURING ELECTROCHEMICAL CAPACITORS

(71) Applicant: NAWATECHNOLOGIES, Aix-en-Provence (FR)

(72) Inventors: Jesus Salvador JAIME FERRER, Aix-En-Provence (FR); Thomas GOISLARD DE MONSABERT, Saint-Maximin-La Sainte-Baume (FR)

(73) Assignee: NAWATECHNOLOGIES, Aix-en-Provence (FR)

(21) Appl. No.: 16/500,181

(22) PCT Filed: Apr. 3, 2018
(86) PCT No.: PCT/FR2018/050820

§ 371 Date: Oct. 2, 2019

(30) Foreign Application Priority Data
Apr. 3, 2017 (FR) 1752839

(51) Int. Cl. H01G 11/86; H01G 11/52; H01G 11/62; H01G 11/80; H01G 11/36; H01G 11/48

(52) U.S. Cl. CPC H01G 11/86; H01G 11/52; H01G 11/48; H01G 11/80; H01G 11/36; H01G 11/62

(57) ABSTRACT

Process for manufacturing an electrochemical capacitor comprising, in a leaktight casing: two electrodes, namely a positive electrode and a negative electrode, a separator that separates the two electrodes, and a liquid electrolyte. The process comprises the deposition of a conductive polymer by electropolymerization on at least one of said electrodes. The electropolymerization being carried out after the two electrodes and the separator have been positioned in said casing. Furthermore, the positive or negative electrodes comprise nano-objects selected from nanopowders, elongated nano-objects, nanofibers, nanotubes, carbon nanotubes, mats of vertically aligned carbon nanotubes, graphene and graphene derivatives.

### TECHNICAL FIELD OF THE INVENTION

The invention relates to the field of electrical capacitors, and more particularly that of electrochemical double-layer capacitors.

### PRIOR ART

Electrochemical double-layer (super)capacitors have been known for a long time. They are based on a capacitive mechanism: the charges adsorb on an electrode by creating an electrochemical double layer. More precisely, they comprise a negative electrode and a positive electrode, separated by a separator and immersed in an electrolyte. If the electrodes and the separator are both flexible sheets, they can be wound; other geometrical shapes exist. The presence of a liquid electrolyte requires a sealed container. A basic presentation of ultracapacitors is given for example in the brochure “Product Guide Maxwell Technologies® BOOSTCAP® Ultracapacitors” published by the Maxwell company in 2009.

These capacitors often use carbon electrodes, in different forms. It is sought to reduce the series resistance of these devices, which leads at each charging and at each discharging operation to the transformation of electrical energy into heat; each solid/solid and solid/liquid interface contributes to the series resistance.

Much work has been carried out to optimize the nature of the carbon materials forming the electrodes. These electrodes must have a large contact surface and good intrinsic electrical conductivity. By way of example, WO 03/038846 (Maxwell Technologies) describes an electrochemical double-layer capacitor comprising electrodes manufactured from carbon powder, namely a first layer of conducting carbon powder, in contact with the metallic collector, and a second layer of active charcoal, in contact with the liquid electrolyte contained in a porous separator. These powders generally contain organic binders. WO 2007/062126 and US 2009/0290288 (Maxwell Technologies) describe electrodes that comprise a mixture of conducting carbon, active charcoal and organic binder. The use of materials with a nanostructured carbon base is considered, and a detailed discussion is given in the article “Review of nanostructured carbon material for electrochemical capacitor applications: advantages and limitations of activated carbon, carbide-derived carbon, zeolite-templated carbon, carbon aerogels, carbon nanotubes, onion-like carbon, and graphene” by W. Gu and G. Yushin, WIRE Energy Environ 2013, doi: 10.1002/wene.102.

Another concept of supercapacitors makes use of so-called pseudocapacitive effects, linked in particular to redox reactions, to intercalation and to electrosorption. Super-capacitors that use electrodes in polymers that have an electronic conductivity and that are able to show a redox behavior have been described in literature. It has been imagined to use these polymers in the form of a coating on a conducting carbon substrate with a high specific surface area. This described for example in the publication “Carbon Redox-Polymer-Gel Hybrid Supercapacitors” by A. Vlad and al., published in Sci. Rep. 6, 22194; doi: 10.1038/srep22194 (2016). A similar approach was implemented on films of carbon nanotubes, see the publication “3-V Solid State Flexible Supercapacitors with Ionic-Liquid-Based Polymer Gel Electrolyte for AC Line Filtering” by Y. J. Kang and al., Appl. Materials & Interfaces, accessible at http://pubs.acs.org/doi/abs/10.1021/acsami.6b02690.

In particular, vertically aligned carbon nanotubes (VACNT), of which the preparation is described for example in WO 2015/071408 (Commissariat à l'Energie Atomique et aux Energies Alternatives), represent a substrate that is propitious for such coatings; this is described in document EP 2 591 151 (Commissariat á l'Energie Atomique et aux Energies Alternatives) and in the thesis “Nanocomposites polythiophènes/nanotubes de carbone alignés: Elaboration, caractérisations et applications aux supercondensateurs en milieu liquide ionique” of Sébastien Lagoutte (Université de Cergy-Pontoise, 2010) as well as the publication “Poly(3-methylthiophene) Vertically Aligned Multi-walled Carbon Nanotubes: Electrochemical Synthesis, Characterizations and Electrochemical Storage Properties in Ionic Liquids” by S. Lagoutte and al., published in Electrochimica Acta 130 (2014), p. 754-765. According to this publication, certain polymers with redox properties can undergo deposition by electropolymerization in an ionic liquid. Then, these VACNT with their deposition of polymer must be transformed and assembled to form a capacitor, i.e. they have to be placed in a case, the separator has to be added, the electrical connections have to be welded, the whole has to be encapsulated, and the electrolyte has to be added through a filling opening, and said opening has to be hermetically sealed.

This is therefore a complex method that entails multiple steps, of which some are steps that entail a very expensive liquid phase (namely ionic liquids), and others are steps of mechanical assembly.

The problem that the present inventions seeks to resolve is to simplify the method of manufacturing supercapacitors that comprise a conducting polymer coated onto a substrate, in particular on a substrate with a carbon-based material, so as to reduce the direct and indirect costs of this method.

### FIGURES

FIG. 1 shows a block diagram of the invention.

FIGS. 2 to 14 show an embodiment of the invention which is described in great detail hereinbelow.

FIG. 2 shows the components of the experimental device used to demonstrate the feasibility of the invention.

FIG. 3 shows the steps of the method that use the components of the experimental device shown in FIG. 2.

FIGS. 4 to 6 relate to an electrochemical cycling test with a progressive increase in voltage: FIG. 4 shows the capacitance according to the voltage applied, FIG. 5 shows the change in the capacitance of the last ten cycles between 0 V and 2.5 V, FIG. 6 shows a voltammogram of the cell with 10% monomer 3MT in an electrolyte EMITFSI diluted in acetonitrile. The sweep rate was 5 mV/s.

FIGS. 7 and 8 relate to an electrochemical cycling test with a direct increase to 2.5 V: FIG. 7 shows a voltammogram of the cell with 10% monomer 3MT in an electrolyte EMITFSI diluted in acetonitrile. The sweep rate was 5 mV/s. FIG. 8 shows the change in the capacitance of the last ten cycles between 0 V and 2.5 V.

FIG. 9 shows a voltammogram of the cell with 10% monomer 3MT in an electrolyte EMITFSI diluted in acetonitrile. The sweep rate was 5 mV/s. The curve A was recorded with a progressive increase, the curve B with a direct increase.

FIG. 10 shows a voltammogram of the cell with 10% monomer 3MT in an electrolyte EMITFSI diluted in acetonitrile, after polymerization in situ (curve C) and without polymer (curve D).

FIGS. 11 to 14 make it possible to appreciate the visual aspect of the inside of the pouch after the cycling tests: FIG. 11 shows the inside of the pouch after electropolymerization. FIG. 12 shows the separator after electropolymerization: on the left the portion of the separator that touched the rear face of the positive electrode, at the center the portion of the separator taken between the two electrodes, on the right the portion of the separator that touches the rear face of the negative electrode. FIG. 13 shows the electrodes after electropolymerization, on the right the negative with activated carbon, on the left the positive formed from VACNT with a deposition of polymer by electropolymerization. FIG. 14 shows a scanning electron microscopy micrograph of the positive after cycling.

### OBJECTS OF THE INVENTION

According to an aspect of the invention, the problem is resolved by carrying out the electrodeposition of the polymer using the same liquid electrolyte as the one that will be used in the capacitor during the operation thereof.

According to another aspect the electrodeposition of the polymer is carried out in the same casing or enclosure as that wherein the capacitor will be encapsulated for the purpose of its operation.

According to another aspect of the invention the electrodeposition of the polymer is carried out by using the same electrodes as those that will be used for the charging and discharging cycles of the capacitor during the operation thereof.

According to another aspect of the invention, the electrodeposition of the polymer is carried out in the same liquid electrolyte as that which will be used in the capacitor during the operation thereof.

According to another aspect of the invention, the electrodeposition of the polymer is carried out in the same casing or enclosure as that wherein the final capacitor will be encapsulated, and by using the same electrodes as those that will be used for the charging and discharging cycles of the capacitor during the operation thereof.

According to an advantageous embodiment, the electrodeposition of the polymer is carried out after the encapsulation of the capacitor.

The electropolymerization is carried out by applying a current or a voltage to said electrodes. According to an alternative, the electrodeposition is carried out by the intermediary of a current and voltage cycling, and/or in pulsed mode, and/or in galvanostatic mode.

A first object of the invention is a method for manufacturing an electrochemical capacitor comprising in a leaktight casing:
two electrodes, namely a positive electrode and a negative electrode,
a separator that separates said positive electrode and said negative electrode, and
a liquid electrolyte,

said method comprises the deposition of a conductive polymer by electropolymerization on at least one of said electrodes, said electropolymerization being carried out after the positioning of said positive electrode, of said negative electrode and of said separator in said casing. Said leaktight casing can be a flexible or rigid casing, and is advantageously selected from the group comprising: plastic pouches, rigid shells made of polymer, shells made of sheet metal lined on the inside with an electrically insulating film, shells made of ceramic, shells made of glass. The term “shell” here includes cases and all types of sealed containers.

Said liquid electrolyte comprises at least one monomer able to form a polymer film by electropolymerization.

In an embodiment that can be combined with all of the aforementioned embodiments, the hermetic sealing of said leaktight casing is carried out before carrying out the electropolymerization.

In an embodiment that can be combined with all of the aforementioned embodiments, said positive and/or negative electrodes include nano-objects, selected preferably from the group comprising: nanopowders, elongated nano-objects, nanofibers, nanotubes, carbon nanotubes (possibly doped with heteroatoms), mats of vertically aligned carbon nanotubes, graphene, graphene derivatives. Said positive and negative electrodes can comprise a porous material with a high specific surface area, such as active charcoal. More particularly, said positive and negative electrodes can comprise carbon nanotubes or nanofibers, preferably vertically aligned.

Advantageously, the polymer film is an electricity-conducting polymer. A list of polymers that are particularly suitable for the execution of the invention is given in the description hereinbelow. Likewise, a list of monomers that are particularly suitable for the execution of the invention is given in the description hereinbelow.

In an embodiment that can be combined with all of the aforementioned embodiments, said electrolyte comprises at least one ionic liquid. A list of ionic liquids that are particularly suitable for the execution of the invention is given in the description hereinbelow.

In an embodiment that can be combined with all of the aforementioned embodiments, said electrolyte also comprises a solvent. A list of solvents that are particularly suitable for the execution of the invention is given in the description hereinbelow.

In an embodiment that can be combined with all of the aforementioned embodiments, said separator is a polypropylene sheet. It is possible to wrap at least the positive electrode or the negative electrode in said separator sheet.

Another object of the invention is an electrochemical capacitor obtainable by the method according to the invention.

### DESCRIPTION

In the present description, the term “polymer” encompasses copolymers. The term “casing” encompasses the enclosures.

In an embodiment, the method according to the invention comprises the following steps:

In a first step a positive electrode, a negative electrode, a separator that separates the two electrodes, and a liquid electrolyte are procured. The latter comprises at least one monomer that is able to form by electropolymerization a polymer film on one of the two electrodes, as well as a casing.

Said liquid electrolyte comprises an ionic liquid, wherein is dissolved said at least monomer and/or oligomer; the liquid electrolyte can include a suitable solvent.

By way of example, the positive electrode can be a mat of VACNT, the negative electrode can be activated carbon, the separator can be a polypropylene membrane, the liquid electrolyte can include an ionic liquid (such as (1-ethyl-3-methyl-imidazolium-bis(trifluoromethane sulfonyl) imide (abbreviated as EMITFSI) or N-butyl-N-methyl-pyrrolidinium bis(trifluoromethane-sulfonyl) imide (abbreviated as PYRTFSI)), monomer (such as 3-methylthiophene (abbreviated as 3MT)), and as a solvent acetonitrile.

In a second step the electrodes and the separator are positioned in said casing, the collectors are positioned which make the connection between each electrode and its terminal located outside said casing, said liquid electrolyte is poured into said casing.

In a third step a polymer film undergoes deposition by electropolymerization on at least one of the electrodes, for example on the positive electrode. This is done through the application of a sufficient voltage to the terminals of the device. The electropolymerization can be done in any suitable way, and in particular in galvanostatic mode, in pulsed mode or in cyclic mode.

Then, the device is able to operate as an electrochemical capacitor. For this its casing has to be closed tightly. In a preferred alternative of the invention said casing is sealingly closed after the second step and before the third step, in order to obtain a device. It is also possible to sealingly close the casing after the third step; this makes it possible to optionally modify the composition of the liquid electrolyte, and even to replace it.

The method according to the invention can be used for many capacitor systems, defined by the nature of the materials that form the substrates of each one of the electrodes, by the nature of the polymer deposited onto one and/or the other of these electrodes, and by the ionic liquid.

According to the invention, said electricity-conducting polymer that has undergone deposition by electrodeposition is formed from one or more polymers or copolymers selected from the group comprising polyfluorenes, polypyrenes, polyazulenes, polynaphthalenes, polypyrroles, polycarbazoles, polyindoles, polyazepines, polyanilines, polythiophenes, poly(p-phenylene sulfide), polyacetylenes, poly(p-phenylene vinylene). In any case the monomers must be chosen according to the desired polymer.

According to the invention, the substrate advantageously comprises nano-objects, which can be selected from the group comprising: nanopowders, elongated nano-objects, nanofibers, nanotubes, carbon nanotubes (possibly doped with heteroatoms), the mats of nanotubes made of vertically aligned carbon, or on a substrate comprising a porous material with a high specific surface area, such as active charcoal.

According to the invention, said at least one monomer is selected from the monomer(s) carrying a double bond and/or an aromatic ring and optionally one or several heteroatoms such as an oxygen atom, a nitrogen atom, a sulfur atom or a fluorine atom, and is preferably selected from the group comprising:
pyrrole and the derivatives thereof, and preferably 3-methyl pyrrole, 3-ethyl pyrrole, 3-butyl pyrrole, 3-bromo pyrrole, 3-methoxy pyrrole, 3,4-dichloro pyrrole and 3,4-dipropoxypyrrole;
carbazole and the derivatives thereof;
aniline and the derivatives thereof;
thiophene and the derivatives thereof, and preferably 3-thiophene acetic acid, 3,4-ethylene dioxythiophene, 3-methyl thiophene, 3-ethyl thiophene, 3-butyl thiophene, 3-bromo thiophene, 3-methoxy thiophene, 3,4-dichloro thiophene and 3,4-dipropoxy thiophene.

According to the invention, said at least one ionic liquid advantageously comprises a cation selected from the group comprising: 1-ethyl-3-methyl imidazolium, 1-methyl-3-propyl imidazolium, 1-methyl-3-isopropyl imidazolium, 1-butyl-3-methyl imidazolium, 1-ethyl-2,3-dimethyl imidazolium, 1-ethyl-3,4-dimethyl imid-azolium, N-propyl pyridinium, N-butyl pyridinium, N-tert-butyl pyridinium, N-tert-butanol-pentyl pyridinium, N-methyl-N-propylpyrrolidinium, N-butyl-N-methylpyrrolidinium, N-methyl-N-pentyl pyrrolidinium, N-propoxyethyl-N-methyl pyrrolidinium, N-methyl-N-propyl piperidinium, N-methyl-N-isopropyl piperidinium, N-butyl-N-methyl piperidinium, N—N-isobutylmethyl piperidinium, N-sec-butyl-N-methyl piperidinium, N-methoxy-N-ethylmethyl piperidinium, N-ethoxyethyl-N-methyl piperidinium; butyl-N—N,N,N-trimethyl ammonium, N-ethyl-N,N-dimethyl-N-propyl ammonium, N-butyl-N-ethyl-N,N-dimethyl ammonium, (1-ethyl-3-methyl-imidazolium-bis(trifluoromethane sulfonyl) imide (abbreviated as EMITFSI), N-butyl-N-methyl-pyrrolidinium bis(trifluoromethane-sulfonyl) imide (abbreviated as PYRTFSI).

According to the invention, said at least one ionic liquid advantageously comprises an anion selected from the group comprising: fluoride (F⁻), chloride (Cl⁻), bromide (Br⁻), iodide (I⁻), perchlorate (ClO₄⁻), nitrate (NO₃⁻), tetrafluoroborate (BF₄⁻), hexafluorophosphate (PF₆⁻), N(CN)₂⁻; RSO₃⁻, RCOO⁻ (where R is an alkyl or phenyl group, possibly substituted); (CF₃)₂PF₄⁻, (CF₃)₃PF₃, (CF₃)₄PF₂⁻, (CF₃)₅PF⁻, (CF₃)₆P⁻, (CF₂SO₃⁻)₂, (CF₂CF₂SO₃⁻)₂, (CF₃SO₂⁻)₂N⁻, CF₃CF₂(CF₃)₂CO⁻, (CF₃SO₂⁻)₂CH⁻, (SF₅)₃C⁻, (CF₃SO₂⁻SO₂⁻)₃C⁻, [O(CF₃)₂C₂(CF₃)₂O]₂PO, CF₃(CF₂)₇SO₃⁻, bis(trifluoro-methanesulfonyl) amide (abbreviated as TFSI), bis(trifluorosulfonyl) amide (abbreviated as FSI).

In a particular embodiment, said at least one ionic liquid comprises at least one cation selected from the group comprising the derivatives of pyridine, pyridazine, pyrimidine, pyrazine, imidazole, pyrazole, triazole, oxazole, triazole, ammonium, pyrrolidine, pyrroline, pyrrole, and piperidine, and at least one anion selected from the group comprising F⁻, Cl⁻, Br⁻, I⁻, NO₃⁻, N(CN)₂⁻, BF₄⁻, ClO₄⁻, PF₆⁻, RSO₃⁻, RCOO⁻ where R is an alkyl or phenol group, (CF₃)₂PF₄⁻, (CF₃)₃PF₃, (CF₃)₄PF₂⁻, (CF₃)₅PF⁻, (CF₃)₆P⁻, (CF₂SO₃)₂, (CF₂CF₂SO₃⁻)₂, (CF₃SO₂⁻)₂N⁻, CF₃CF₂(CF₃)₂CO⁻, (CF₃SO₂)₂CH⁻, (SF₅)₃C, (CF₃SO₂)₃C, [O(CF₃)₂C₂(CF₃)₂O]₂PO⁻, CF₃ (CF₂)₇SO₃⁻, 1-ethyl-3-methymimidazole bis(trifluoro-methyl-sulfonyl)imide (abbreviated as [EMIM][Tf₂N]).

According to the invention, said at least one solvent is selected from the group comprising acetic acid, methanol, ethanol, liquid glycols (in particular ethyleneglycol and propyleneglycol), halogenated alkanes (in particular dichloromethane), dimethylformamide (abbreviated as DMF), ketones (in particular acetone and 2-butanone), acetonitrile, tetrahydrofuran (abbreviated as THF), N-methylpyrrolidone (abbreviated as NMP), dimethyl sulfoxide (abbreviated as DMSO), propylene carbonate.

By way of example, it is possible to use the galvanostatic electrodeposition method of poly(3-methylthiophene) on carbon nanotubes using monomers of 3-methyl-thiophene (abbreviated as 3MT) dissolved in ionic liquids of the EMITFSI type [=(1-ethyl-3-methyl-imidazolium-bis(trifluoromethane sulfonyl) imide] or PYRTFSI [=N-butyl-N-methyl-pyrrolidinium bis(trifluoromethane-sulfonyl) imide] which is described in the aforementioned publication of S. Lagoutte et al.

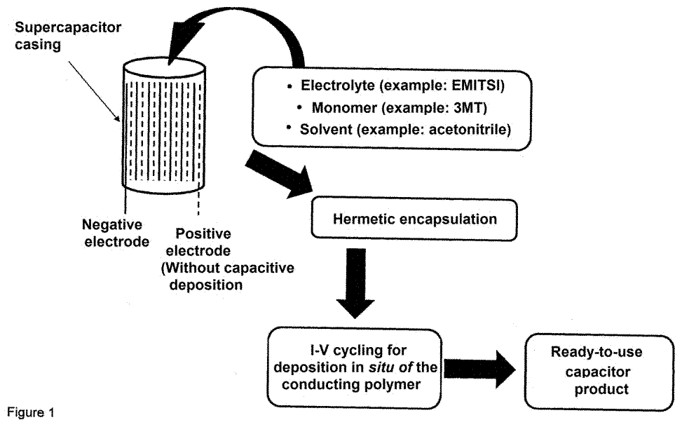

An embodiment of the invention is diagrammatically shown in FIG. 1. In the leaktight casing (which can be for example a flexible pouch or a solid shell) is positioned an assembly of the positive and negative electrodes, separated by a separator. In FIG. 1, the positive electrode is represented by broken lines in order to distinguish it from the negative electrode represented by a solid line: the choice of a broken line does not mean in any way an electrical discontinuity of the electrode. The liquid electrolyte comprises the ionic liquid EMITFSI, the acetonitrile solvent and the monomer 3MT. The leaktight casing is hermetically encapsulated, the electrodeposition is carried out (for example I-V cycling), and a ready-to-use capacitor product is obtained.

The method according to the invention has many advantages.

It simplifies the assembly of the capacitor: the assembly of the device (including the positioning and the connecting of the electrical contacts) is done before the deposition of the polymer, the deposition of the polymer can take place in the sealed devices. Thus the number of steps is reduced, and in particular the handling of the electrodes after the electrodeposition of the polymer is avoided.

The method according to the invention also avoids the loss of electrolyte: the electrolyte wherein the method of electrodeposition of the polymer takes place can be used directly for the operation of the electrochemical capacitor, it is in fact the same liquid (except that it loses monomer during the electrodeposition). No drying of the electrodes is required before the assembly of the device, because the electrodes are wetted only once they are positioned in their casing.

### EXAMPLES

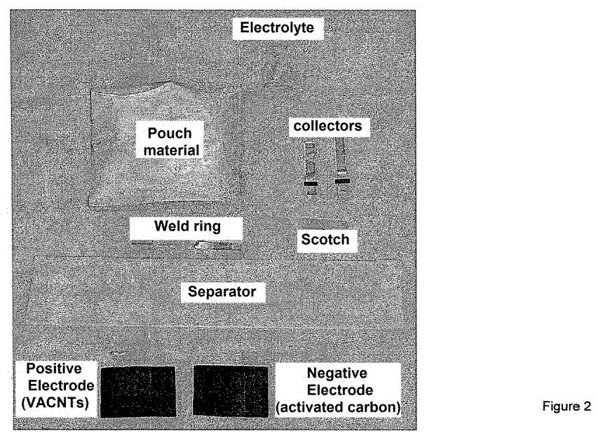

The invention has been implemented with an experimental device. To do this, the following components were procured: a pouch made of plastic material as a casing, two metallic strips as collectors, two metallic strips as a weld ring, a ternary liquid mixture (comprising a monomer (3MT, at a rate of 10% by volume), an ionic liquid (EMITFSI) and a solvent (acetonitrile, abbreviated here as ACN)) as electrolyte, a polypropylene membrane 25 μm thick (Celgard® 2500) as a separator, a length of adhesive tape (also called “scotch”), a negative electrode made of activated carbon 120 μm thick and a positive electrode made of vertically aligned carbon nanotubes (multi-sheet, thickness of the mat of VACNT about 10 μm) deposited onto a substrate made of an aluminum sheet 20 μm thick, knowing that the electrodes are provided with a metallic contact strip. These components are shown in FIG. 2.

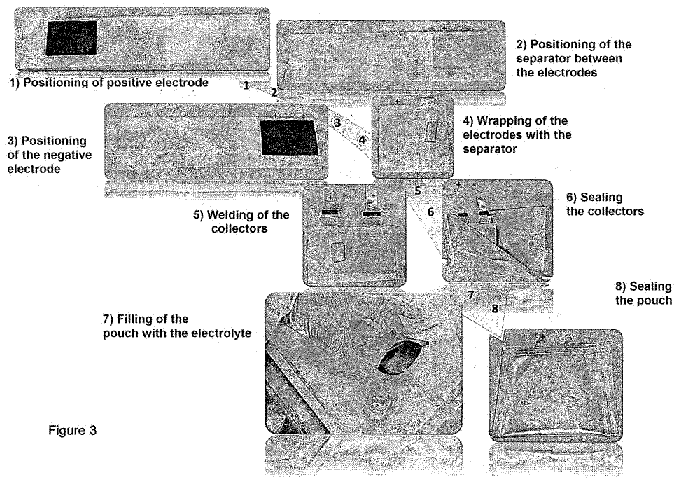

With these components the method was implemented according to the invention, as is shown in FIG. 3: the positive electrode was positioned on the separator, the separator was positioned, the negative electrode was positioned on the separator, the electrodes were wrapped with the separator, the collectors were welded to the metallic strips of the electrodes (the weld rings make it possible to improve the weld between the collector and the electrode and also to rigidify the collectors), the collectors were sealed to the pouch, the pouch was filled with the liquid mixture described hereinabove, and the pouch was sealed; only the collectors extended beyond the outside of the pouch. Two identical pouches were prepared in this way. A third pouch was prepared in the same way as the two preceding ones, but without monomer in the liquid mixture.

Two conditions of electropolymerization were studied with pouches 1 and 2.

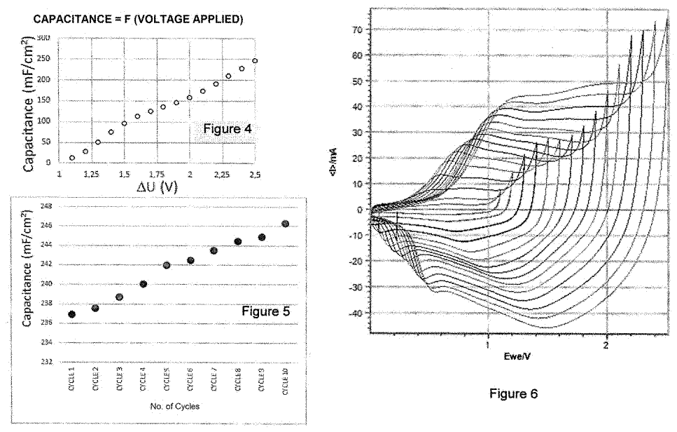

In a first test one of these pouches (pouch 1) was subjected to an electrochemical cycling test with a progressive increase in voltage: From 0 V to 1 V, from 0 V to 1.1 V, from 0 V to 1.2 V and so on until 2.5 V; ten cycles were thus executed with a sweep rate of 5 mV/s. A voltammogram representing this cycling test is shown in FIG. 6. FIG. 4 shows the capacitance according to the voltage applied; FIG. 5 shows the change in the capacitance of the last ten cycles between 0 V and 2.5 V.

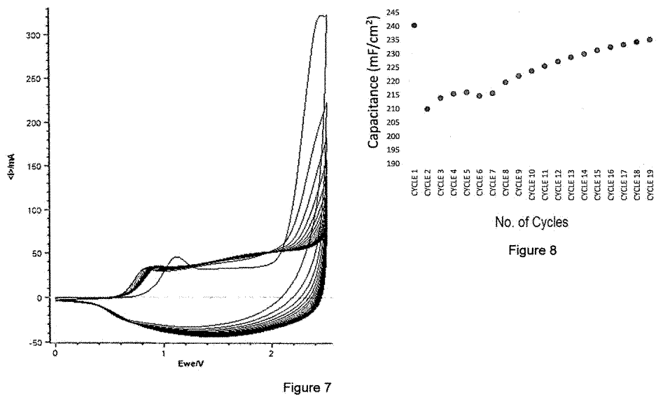

In a second test the other of these pouches (pouch 2) was subjected to twenty direct cycles between 0 and 2.5 V. FIG. 7 shows the voltammogram. A very strong current at a voltage close to around 2.3 V is noted; this voltage spike decreases with the number of cycles. FIG. 8 shows the change in the capacitance of the last ten cycles between 0 V and 2.5 V.

FIG. 9 compares the two systems after polymerization in situ: the curve A represents the electropolymerized sample with a progressive increase in the voltage (pouch 1), the curve B represents the electropolymerized sample with a direct increase (pouch 2). The capacitances obtained with these two alternatives are rather close, but it is observed that the peak in electroactivity is located for the conditions of progressive increase at about 0.95 V, while it is located at about 1.1 V for a direct increase.

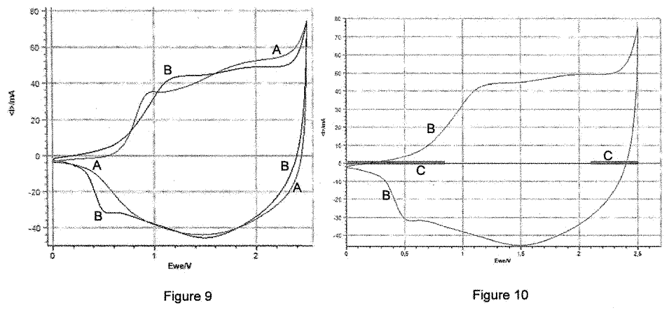

FIG. 10 compares the curve B of FIG. 9 with the curve obtained in a control pouch, prepared in a manner identical to that of the pouch 2, but without monomer in the liquid mixture (curve C): it can be seen that without monomer the electropolymerization does not take place, and the device is not able to operate as a capacitor.

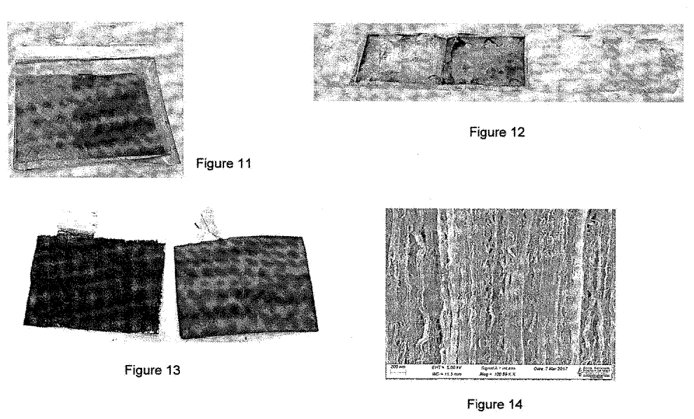

FIGS. 11 to 14 make it possible to appreciate the visual aspect of the inside of the pouch after the cycling tests. FIG. 11 shows the inside of the pouch; no degradation is observed. FIG. 12 shows the separator sheet after electropolymerization: on the left the portion of the separator that was in contact with the rear facer of the positive electrode, at the center the portion of the separator taken between the two electrodes, on the right the portion of the separator that was in contact with the rear face of the negative electrode. FIG. 13 shows the electrodes after electropolymerization, on the right the negative electrode made of activated carbon, on the left the positive electrode formed from VACNT with a deposition of polymer by electropolymerization. FIG. 14 shows a scanning electron microscopy micrograph of the positive electrode after cycling. The electrolyte after the test, the coloration disappears which confirms the consumption of monomer. The absence of coloration after polymerization demonstrates the absence of oligomers.

This example shows that the method according to the invention allows for the electropolymerization directly in the enclosure of the capacitor, and that such a device operates as a capacitor.

Capacitors have thus been manufactured of which the capacitance reached 6,600 mFa and an energy density of about 0.9 Wh/kg, reduced to the mass of the final device.

Capacitors were also carried out with other solvents (for example propylene carbonate), other monomer and other ionic liquids.

1. Method for manufacturing an electrochemical capacitor comprising in a leaktight casing:
two electrodes, namely a positive electrode and a negative electrode,
a separator that separates said positive electrode and said negative electrode, and
a liquid electrolyte,
said method comprises the deposition of a conductive polymer by electropolymerization on at least one of said electrodes, said electropolymerization being carried out after the two electrodes and the separator have been positioned in said casing.

2. Method according to claim 1, wherein said liquid electrolyte comprises at least one monomer able to form a polymer film by electropolymerization.

3. Method according to claim 1, wherein said electropolymerization is carried out by applying a current or a voltage to said electrodes.

4. Method according to claim 1, wherein said electrodes are left in position after the electropolymerization.

5. Method according to claim 1, wherein said liquid electrolyte is left in position after the electropolymerization.

6. Method according to claim 1, wherein the hermetic sealing of said leaktight casing is carried out before carrying out the electropolymerization.

7. Method according to claim 1, wherein said leaktight casing is a flexible or rigid casing, selected preferably from the group comprising: plastic pouches, rigid shells made of polymer, shells made of sheet metal lined on the inside with an electrically insulating film, shells made of ceramic, shells made of glass.

8. Method according to claim 1, wherein said electropolymerization comprises a current and voltage cycling, and/or is carried out in pulsed mode, and/or is carried out in galvanostatic mode.

9. Method according to claim 1, wherein said positive and/or negative electrodes comprise nano-objects, selected preferably from the group comprising: nanopowders, elongated nano-objects, nanofibers, nanotubes, carbon nanotubes (possibly doped with heteroatoms), mats of vertically aligned carbon nanotubes, graphene, graphene derivatives.

10. Method according to claim 1, wherein said positive and negative electrodes comprise a porous material with a high specific surface area, such as active charcoal.

11. Method according to claim 1, wherein said positive and negative electrodes comprise carbon nanotubes or nanofibers, preferably vertically aligned.

12. Method according to claim 1, wherein said polymer film is an electrically conductive polymer.

13. Method according to claim 1, wherein said polymer film is formed from one or several polymers or copolymers selected from the group comprising polyfluorenes, polypyrenes, polyazulenes, polynaphthalenes, polypyrroles, polycarbazoles, polyindoles, polyazepines, polyanilines, polythiophenes, poly(p-phenylene sulfide), polyacetylenes, poly(p-phenylene vinylene).

14. Method according to claim 1, wherein said at least one monomer is selected from the monomer(s) carrying a double bond and/or an aromatic ring and optionally a heteroatom such as an oxygen atom, a nitrogen atom, a sulfur atom or a fluorine atom, and is preferably selected from the group comprising:
pyrrole and the derivatives thereof, and preferably 3-methyl pyrrole, 3-ethyl pyrrole, 3-butyl pyrrole, 3-bromo pyrrole, 3-methoxy pyrrole, 3,4-dichloro pyrrole and 3,4-dipropoxypyrrole;
carbazole and the derivatives thereof;
aniline and the derivatives thereof;
thiophene and the derivatives thereof, and preferably 3-thiophene acetic acid, 3,4-ethylene dioxythiophene, 3-methyl thiophene, 3-ethyl thiophene, 3-butyl thiophene, 3-bromo thiophene, 3-methoxy thiophene, 3,4-dichloro thiophene and 3,4-dipropoxy thiophene.

15. Method according to claim 1, wherein said electrolyte comprises at least one ionic liquid.

16. Method according to claim 1, wherein said at least one ionic liquid comprises at least one cation selected from the group comprising: 1-ethyl-3-methyl imidazolium, 1-methyl-3-propyl imidazolium, 1-methyl-3-isopropyl imidazolium, 1-butyl-3-methyl imidazolium, 1-ethyl-2,3-dimethyl imidazolium, 1-ethyl-3,4-dimethyl imid-azolium, N-propyl pyridinium, N-butyl pyridinium, N-tert-butyl pyridinium, N-tert-butanol-pentyl pyridinium, N-methyl-N-propylpyrrolidinium, N-butyl-N-methylpyrrolidinium, N-methyl-N-pentyl pyrrolidinium, N-propoxyethyl-N-methyl pyrrolidinium, N-methyl-N-propyl piperidinium, N-methyl-N-isopropyl piperidinium, N-butyl-N-methyl piperidinium, N—N-isobutylmethyl piperidinium, N-sec-butyl-N-methyl piperidinium, N-methoxy-N-ethylmethyl piperidinium, N-ethoxyethyl-N-methyl piperidinium; butyl-N—N,N,N-trimethyl ammonium, N-ethyl-N,N-dimethyl-N-propyl ammonium, N-butyl-N-ethyl-N,N-dimethyl ammonium, (1-ethyl-3-methyl-imidazolium-bis(trifluoromethane sulfonyl) imide, N-butyl-N-methyl-pyrrolidinium bis(trifluoromethane-sulfonyl) imide.

17. Method according to claim 1, wherein said at least one ionic liquid comprises at least one anion selected from the group comprising: fluoride (F⁻), chloride (Cl⁻), bromide (Br⁻), iodide (I⁻), perchlorate (ClO₄⁻), nitrate (NO₃⁻), tetrafluoroborate (BF₄⁻), hexafluorophosphate (PF₆⁻), N(CN)₂⁻; RSO₃⁻, RCOO⁻ (where R is an alkyl or phenyl group, possibly substituted); (CF₃)₂PF₄⁻, (CF₃)₃PF₃, (CF₃)₄PF₂⁻, (CF₃)₅PF⁻, (CF₃)₆P⁻, (CF₂SO₃⁻)₂, (CF₂CF₂SO₃⁻)₂, (CF₃SO₂)₂N⁻, CF₃CF₂(CF₃)₂CO⁻, (CF₃SO₂⁻)₂CH⁻, (SF₅)₃C⁻, (CF₃SO₂SO₂)₃C⁻, [O(CF₃)₂C₂(CF₃)₂O]₂PO, CF₃(CF₂)₇SO₃⁻, bis(trifluoro-methanesulfonyl) amide, bis(trifluorosulfonyl) amide.

18. Method according to claim 1, wherein said at least one ionic liquid comprises
at least one cation selected from the group comprising the derivatives of pyridine, pyridazine, pyrimidine, pyrazine, imidazole, pyrazole, triazole, oxazole, triazole, ammonium, pyrrolidine, pyrroline, pyrrole, and piperidine, and
at least one anion selected from the group comprising F⁻, Cl⁻, Br⁻, I⁻, NO₃⁻, N(CN)₂⁻, BF₄⁻, ClO₄⁻, PF₆⁻, RSO₃⁻, RCOO⁻, where R is an alkyl or phenol group, (CF₃)₂PF₄⁻, (CF₃)₃PF₃, (CF₃)₄PF₂⁻, (CF₃)₅PF⁻, (CF₃)₆P⁻, (CF₂SO₃⁻)₂, (CF₂CF₂SO₃⁻)₂, (CF₃SO₂⁻)₂N⁻, CF₃CF₂(CF₃)₂CO⁻, (CF₃SO₂⁻)₂CH⁻, (SF₅)₃C, (CF₃SO₂⁻)₃C, [O(CF₃)₂C₂(CF₃)₂O]₂PO⁻, CF₃(CF₂)₇SO₃⁻, 1-ethyl-3-methymimidazole bis(trifluoro-methyl-sulfonyl) imide ([EMIM][Tf₂N]).

19. Method according to claim 1, in said liquid electrolyte comprises in addition at least one solvent.

20. Method according to claim 19, wherein said at least one solvent is selected from the group comprising acetic acid, methanol, ethanol, liquid glycols (in particular ethyleneglycol and propyleneglycol), halogenated alkanes (in particular dichloromethane), dimethylformamide, ketones (in particular acetone and 2-butanone), acetonitrile, tetrahydrofuran, N-methylpyrrolidone, dimethyl sulfoxide, propylene carbonate.

21. Method according to claim 1, wherein at least one of said positive or negative electrodes is wrapped in said separator.

22. Method according to claim 1, wherein said separator is a sheet of polypropylene.

23. Electrochemical capacitor able to be obtained by the method according to claim 1.
